(19) United States
(12) Patent Application Publication
(10) Pub. No.: US 2007/0019132 A1
(43) Pub. Date: Jan. 25, 2007

(54) Microlens substrate array, method for manufacturing the same, and three-dimensional display apparatus employing microlens substrate

(75) Inventors: Jae-hyun Kim, Suwon-si (KR); Kee-han Uh, Yongin-si (KR); Won-sang Park, Yongin-si (KR); Hae-young Yun, Suwon-si (KR); Sang-woo Kim, Suwon-si (KR); Jae-Young Lee, Yongin-si (KR); Jae-ik Lim, Chuncheon-si (KR); Young-Joo Chang, Suwon-si (KR); Seung-Kyu Lee, Yongin-si (KR); Poundaleva Irina, Yongin-si (KR); Sung-eun Cha, Geoje-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/323,195

(22) Filed: Dec. 30, 2005

(30) Foreign Application Priority Data
Dec. 31, 2004 (KR) 10-2004-0118010

(51) Int. Cl. G02F 1/1335

(52) U.S. Cl. 349/95

(57) ABSTRACT

A method of manufacturing a microlens substrate includes forming a microlens sheet of a photosensitive resin including a lenticular lens array on a lower substrate, exposing the microlens sheet to light through a mask dividing the lenticular lens array into a plurality of portions respectively corresponding to a plurality of cells and defining a boundary between each of the plurality of cells, planarizing a portion of the microlens sheet corresponding to the boundary, and forming a seal line on the planarized boundary to combine the lower substrate with a corresponding upper substrate.

### CROSS-REFERENCE TO RELATED APPLICATION

This application claims priority from Korean Patent Application No. 10-2004-118010 filed on Dec. 31, 2004, the disclosure of which is incorporated herein by reference in its entirety.

### BACKGROUND OF THE INVENTION

1. Technical Field

The present disclosure relates to a microlens substrate array, a method of manufacturing the same, and a three-dimensional (3D) display apparatus including a microlens substrate, and more particularly, to a microlens substrate array that can be fabricated on glass using an alignment key formed on a substrate, a method of manufacturing the same, and a 3D display apparatus including a microlens substrate.

2. Discussion of the Related Art

A three-dimensional display produces different images for a viewer's left and right eyes, thereby providing a sense of depth and a stereoscopic effect. Displaying a stereoscopic image allows the viewer to recognize the 3D arrangement of objects.

An autostereoscopic device is commonly used as a direct-view display in which an observer can see a 3D image without special instruments such as, for example, stereo glasses. The autostereoscopic device in which a lenticular lens sheet or a barrier sheet is mounted on a display panel produces a stereo image by separating the left-eye and right-eye images produced on the display panel so that the left eye sees only the left eye image and the right eye sees only the right eye image.

A conventional 3D display apparatus includes a display panel producing R, G, and B image signals, a microlens substrate with a lenticular sheet that is mounted on the display panel and converts R, G, and B image signals into 3D images, and a switching panel that is mounted on the microlens substrate and converts a 2D image to a 3D image or vice versa.

The conventional 3D display apparatus in which the microlens substrate with the lenticular sheet is disposed on the display panel uses a polarization-conversion technique. 3D displays are classified into portrait-type (PT) and landscape type (LT) displays depending on the arrangement of a color filter and lenticular lenses on a lenticular lens sheet.

When long sides of the RGB subpixels in a single pixel extend along a longitudinal direction of a liquid crystal panel, a PT display is configured such that lenticular lenses of a lenticular sheet are arranged in parallel along the longitudinal direction of the subpixels, i.e., in the vertical direction of a screen. An LT display is configured such that lenticular lenses are aligned on a lenticular lens substrate in parallel along the transverse direction of the subpixels, i.e., in the horizontal direction of the screen.

The PT display commonly uses a structure in which two subpixels correspond to one lenticular lens so that three primary colors generated by six adjacent subpixels, i.e., left-eye and right-eye data signals, reach the left and right eyes, respectively.

A conventional method of manufacturing the microlens substrate having the above-mentioned configuration in the conventional 3D display includes applying a resin on a lower substrate, placing the resin into a mold for a lenticular lens array to form the shape of a lenticular lens, thereby completing a microlens sheet cell by cell, cutting the microlens sheet into individual cells, and mounting an upper substrate on each individual cell.

High-volume production of the microlens substrate is difficult with the conventional method, which fabricates the microlens sheet cell by cell due to a mold size limitation.

### SUMMARY OF THE INVENTION

Embodiments of the present invention provide a microlens substrate array with excellent reproducibility that can be fabricated on glass for high-volume production, a three-dimensional (3D) display apparatus including a microlens substrate, and a method of manufacturing the microlens substrate.

According to an embodiment of the present invention, a microlens substrate array includes an upper transparent substrate and a lower transparent substrate facing the upper transparent substrate, and a microlens sheet of a photosensitive resin formed between the upper and lower substrates, the microlens sheet including a plurality of lenticular lens arrays corresponding to a plurality of cells arranged on a surface of the microlens sheet and planar surfaces formed along edges of each of the plurality of cells.

According to an embodiment of the present invention, a microlens substrate array includes an upper transparent substrate and a lower transparent substrate facing the upper transparent substrate, a microlens sheet made of a photosensitive resin, including a plurality of lenticular lens arrays that are formed on the lower substrate between the upper and lower substrates and correspond to a plurality of cells and exposing the lower substrate along edges of each of the plurality of cells, and a seal line directly contacting the exposed lower substrate and the upper substrate and combining the upper substrate with the lower substrate.

According to an embodiment of the present invention, a three-dimensional display apparatus includes a display panel producing an image, and a microlens substrate including an upper transparent substrate that is disposed on of the display panel and transmits the image, a lower transparent substrate facing the upper transparent substrate, and a microlens sheet of a photosensitive resin that is formed between the upper and lower substrates and includes a lenticular lens array and planar surfaces formed along edges of the lenticular lens array.

According to an embodiment of the present invention, a three-dimensional display apparatus includes a display panel producing an image, and a microlens substrate including an upper transparent substrate that is disposed on the display panel and transmits the image, a lower transparent substrate facing the upper transparent substrate, a microlens sheet made of a photosensitive resin, which includes a lenticular lens array, that is formed on the lower substrate between the upper and lower substrates, and exposes the lower substrate along edges of the lenticular lens array, and a seal line directly contacting the exposed lower substrate and the upper substrate and combining the upper substrate with the lower substrate.

According to an embodiment of the present invention, a method of manufacturing a microlens substrate includes forming a microlens sheet of a photosensitive resin including a lenticular lens array on a lower substrate, exposing the microlens sheet to light through a mask dividing the lenticular lens array into a plurality of portions respectively corresponding to a plurality of cells and defining a boundary between each of the plurality of cells, planarizing a portion of the microlens sheet corresponding to the boundary, and forming a seal line on the planarized boundary to combine the lower substrate with a corresponding upper substrate.

According to an embodiment of the present invention, a method of manufacturing a microlens substrate includes forming a microlens sheet of a photosensitive resin including a lenticular lens array on a lower substrate, exposing the microlens sheet to light through a mask dividing the lenticular lens array into a plurality of portions respectively corresponding to a plurality of cells and defining a boundary between each of the plurality of cells, removing a portion of the microlens sheet corresponding to the boundary to expose the lower substrate, and forming a seal line on the boundary formed on the exposed lower substrate to combine the lower substrate with a corresponding upper substrate.

### BRIEF DESCRIPTION OF THE DRAWINGS

Preferred embodiments of the present disclosure can be understood in more detail from the following description taken in conjunction with the accompanying drawings in which:

FIG. 1A is a perspective view illustrating functional blocks of a three-dimensional (3D) display apparatus according to an embodiment of the present invention;

FIG. 1B is a perspective view illustrating functional blocks of a 3D display apparatus according to another embodiment of the present invention;

FIG. 2 is a cross-sectional view taken along the line AA′ or BB′ of the 3D display apparatus of FIG. 1A or 1 B;

FIG. 3 is an exploded perspective view of a microlens substrate array according to an embodiment of the present invention;

FIGS. 4A-4G are cross-sectional views showing a method of manufacturing a microlens substrate according to an embodiment of the present invention;

FIG. 5 is a cross-sectional view of a 3D display apparatus according to an embodiment of the present invention;

FIG. 6 is an exploded perspective view of a microlens substrate array according to an embodiment of the present invention;

FIGS. 7A-7G are cross-sectional views showing a method of manufacturing a microlens substrate according to an embodiment of the present invention; and

FIGS. 8A and 8B illustrate alignment keys that are formed on the lower substrate shown in FIG. 3 or 6, according to embodiments of the present invention.

### DETAILED DESCRIPTION OF PREFERRED EMBODIMENTS

Preferred embodiments of the present invention will be described below in more detail with reference to the accompanying drawings. The present invention may, however, be embodied in many different forms and should not be construed as limited to the embodiments set forth herein.

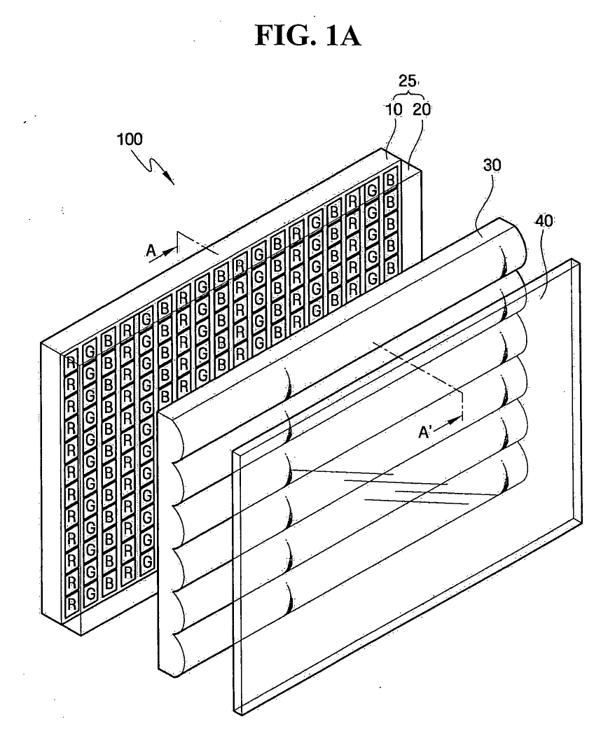

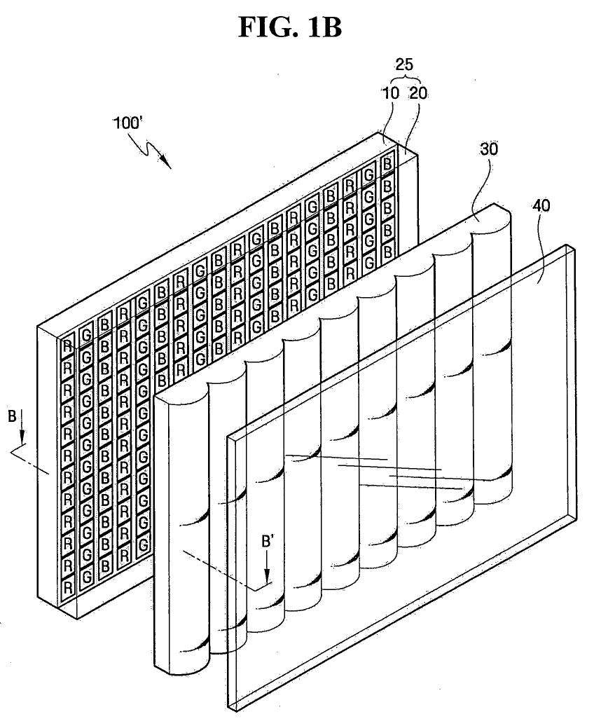

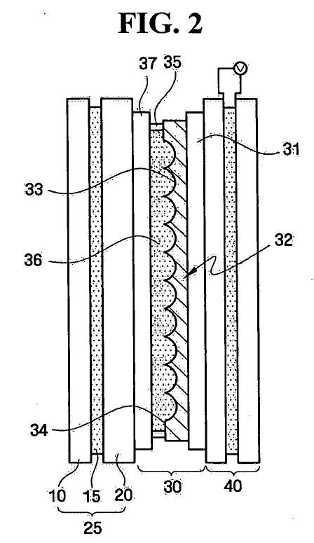

FIG. 1A is a perspective view illustrating functional blocks of a three-dimensional (3D) display apparatus according to an embodiment of the present invention. FIG. 1 B is a perspective view illustrating functional blocks of a 3D display apparatus according to another embodiment of the present invention. FIG. 2 is a cross-sectional view taken along the line AA′ or BB′ of the 3D display apparatus of FIG. 1A or 1B.

Referring to FIGS. 1A and 2, a 3D display apparatus 100 includes a display panel 25, a microlens substrate 30, and a switching panel 40.

The display panel 25 may be, for example, a liquid crystal display (LCD), a plasma display panel (PDP), a field emission device (FED), or an organic electro-luminescence display (OELD), which can produce red, green, and blue colors. The 3D display apparatus 100 is hereinafter described as using an LCD.

The display panel 25 controls transmittance of light passing through a liquid crystal layer 15 depending on the magnitude of an applied voltage, thereby displaying images such as, for example, a variety of characters, numbers, and icons. The display panel 25 produces a common RGB image when displaying a common 2D image. When displaying a 3D image, adjacent subpixels in the display panel 25 generate images containing parallax.

The display panel 25 includes a thin film transistor (TFT) substrate 10, a color filter substrate 20 facing the TFT substrate 10, and a liquid crystal layer 15 positioned between the TFT substrate 10 and the color filter substrate 20.

While not shown in FIG. 1A, the TFT substrate 10 includes a plurality of gate lines, a plurality of data lines, and a plurality of subpixels. The plurality of gate lines extend in a row direction and supply gate signals, and the plurality of data lines extend in a column direction and supply data signals. The plurality of subpixels are arranged in a matrix defined by the crossing of the plurality of gate lines and the plurality of data lines. Short sides of the subpixels extend in a transverse direction of the display panel 25 and long sides thereof extend in a longitudinal direction. Each subpixel includes a switching device, a storage capacitor, and a liquid crystal capacitor.

The switching device is formed at an intersection between a gate line and a data line and includes an output terminal connected to terminals of the storage capacitor and the liquid crystal capacitor. The other terminal of the storage capacitor may be connected to a reference electrode (separate wire type) or to a previous gate line (previous gate type).

The color filter substrate 20 is disposed on the TFT substrate 10 and includes red, green, and blue color filters that correspond to subpixels and display corresponding colors. The reference electrode is formed on the color filter using a transparent conducting material such as indium tin oxide (ITO) or indium zinc oxide (IZO).

The liquid crystal layer 15 having dielectric anisotropy is filled between the TFT substrate 10 and the color filter substrate 20. The liquid crystal layer 15 with a thickness of about 5 μm has a twisted nematic (TN) alignment structure. The alignment direction of liquid crystals in the liquid crystal layer 15 is altered by an externally applied voltage to control the transmittance of light passing through the liquid crystal layer 15.

When the display panel 25 is an LCD, the display panel 25 may further include a backlight unit (not shown) with a light source located behind the LCD. Light emitted from the backlight unit to the display panel 25 is transmitted into the color filter substrate 20 through the liquid crystal layer 15. The amount of light transmitted is adjusted according to the alignment direction of liquid crystals in the liquid crystal layer 15.

The light transmitted through the display panel 25 passes through the microlens substrate 30 disposed on the display panel 25. The microlens substrate 30 includes an upper transparent substrate 37, a lower transparent substrate 31, and a microlens sheet 32 interposed between the upper and lower transparent substrates 37 and 31. The microlens substrate 30 directs three primary colors generated by subpixels, corresponding to left-eye and right-eye data signals, to an appropriate eye.

Referring to FIG. 2, the microlens sheet 32 is disposed on the lower substrate 31 facing the upper substrate 37, and includes a lenticular lens array 33 comprising a plurality of lenticular lenses arranged in parallel and planar surfaces 34 formed along edges of the lenticular lens array 33.

A pitch of the lenticular lens array 33 is set to have a constant relationship with a horizontal pitch of subpixels along the transverse direction of the display panel 25. While the 3D display apparatus 100 is configured such that one lenticular lens corresponds to two subpixels, the lenticular lens may correspond to three or more subpixels depending on the number of perspectives.

While the 3D display apparatus 100 is a landscape type display, a portrait type display apparatus 100′ of FIG. 1B may be used. As shown in FIG. 2, the microlens sheet 32 includes the concave lenticular lens array 33. Alternatively, the microlens sheet 32 may use a convex lenticular lens array to achieve the same effect.

Seal lines 35 are formed on the planar surface 34 of the microlens sheet 32 and combine the upper substrate 37 with the lower substrate 31. The seal lines 35 make a gap between the upper and lower substrates 37 and 31 to inject liquid crystals and prevent the injected liquid crystals from escaping out of the gap. The seal lines 35 are formed by, for example, patterning a thermosetting epoxy resin in a desired shape.

The height of the seal lines 35 is about several micrometers, and a peak-to-valley height of the lenticular lens array 33 is about several tens of micrometers. Since the height of the seal lines 35 is less than the peak-to-valley height, adequate bonding between the upper and lower substrates 37 and 31 cannot be achieved if the lenticular lens array 33 is formed on the planar surface where the seal lines 35 are formed. Thus, the microlens sheet 32 is designed such that the lenticular lens array 33 is disposed at the center and the seal lines 35 are placed on the planar surface 34 formed along the edges of the lenticular lens array 33, thereby achieving reliable bonding between the upper and lower substrates 37 and 31.

A liquid crystal layer 36 is formed in the gap between the upper and lower substrates 37 and 31.

The switching panel 40 is disposed on the display panel 25 and spaced apart from the display panel 25, and enables the display apparatus 100 to selectively display a 2D or 3D image in response to a switching signal.

For example, the switching panel 40 transmits all of the light from the TFT substrate 10 when displaying a 2D image and includes a structure corresponding to pixel information on the TFT substrate 10. For example, when the 3D image is displayed, the switching panel 40 comprises an effective image display region that can transmit light and a selective blocking region surrounding the effective image display region. The selective blocking region controls whether to block light in response to the switching signal.

The switching panel 40 may comprise a liquid crystal panel that can turn light on or off according to the switching signal. For example, the switching panel 40 may be a super twisted nematic (STN) liquid crystal panel or a twisted nematic (TN) liquid crystal panel.

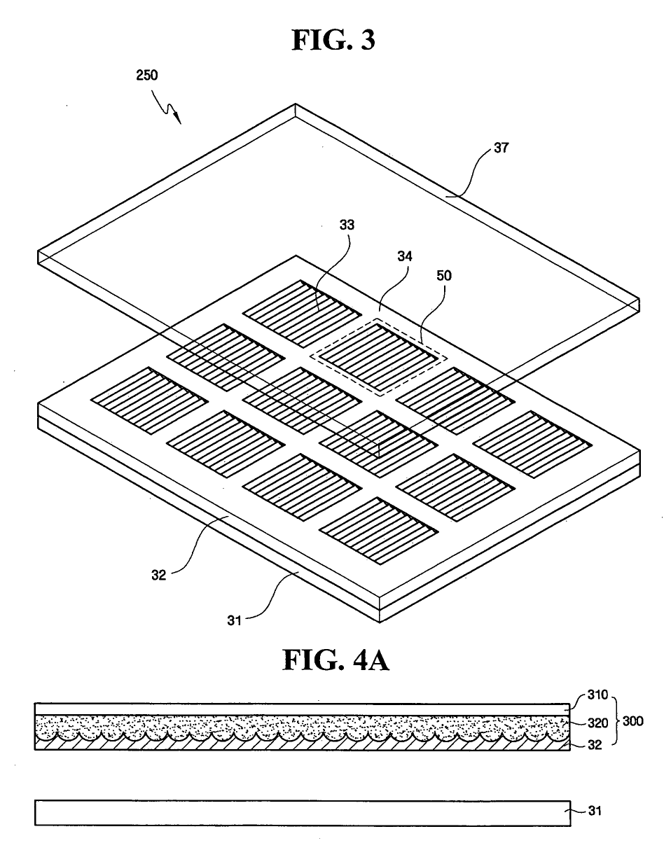

FIG. 3 is an exploded perspective view of a microlens substrate array 250 according to an embodiment of the present invention. The microlens substrate array 250 includes a plurality of microlens substrates 30 arranged on the same surface. Referring to FIG. 3, the microlens substrate array 250 includes a lower transparent substrate 31, an upper transparent substrate 37 facing the lower substrate 31, a microlens sheet 32 that is interposed between the upper and lower transparent substrates 37 and 31 and a plurality of lenticular lens arrays 33 corresponding to a plurality of cells 50 arranged on the surface of the microlens sheet 32.

The upper substrate 37 combines with the lower substrate 31 to cover a top surface of the lower substrate 31, with the microlens sheet 32 interposed therebetween.

The microlens sheet 32 comprises a photosensitive resin and includes the plurality of lenticular lens arrays 33 corresponding to the plurality of cells 50 arranged on the surface of the microlens sheet 32. Planar surfaces 34 are formed along edges of each of the plurality of cells 50. A seal line (not shown) is disposed on the planar surface 34 to achieve adequate bonding between the upper and lower substrates 37 and 31 without being affected by irregularities. of the lenticular lens array 33.

In this way, the plurality of cells 50 is defined on the microlens sheet 32 in the microlens substrate array 250. Thus, the microlens substrate array 250 can be cut into individual cells 50 and divided into a plurality of microlens substrates 30.

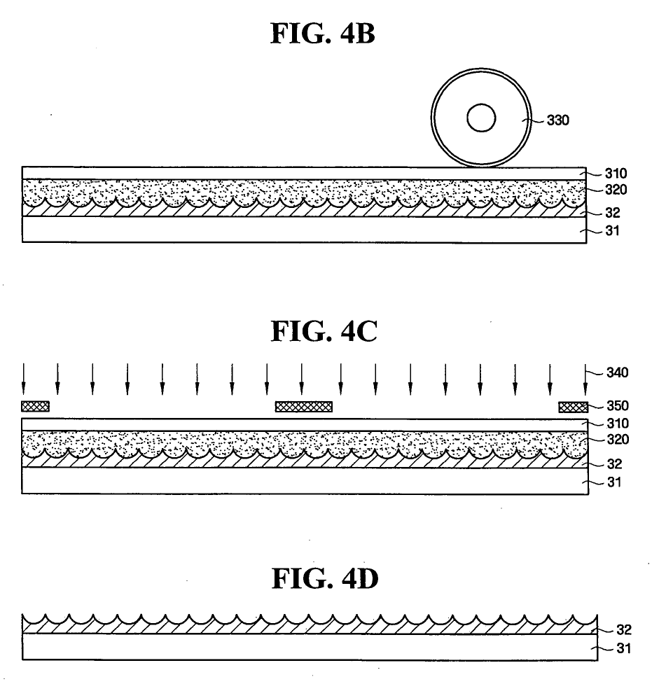

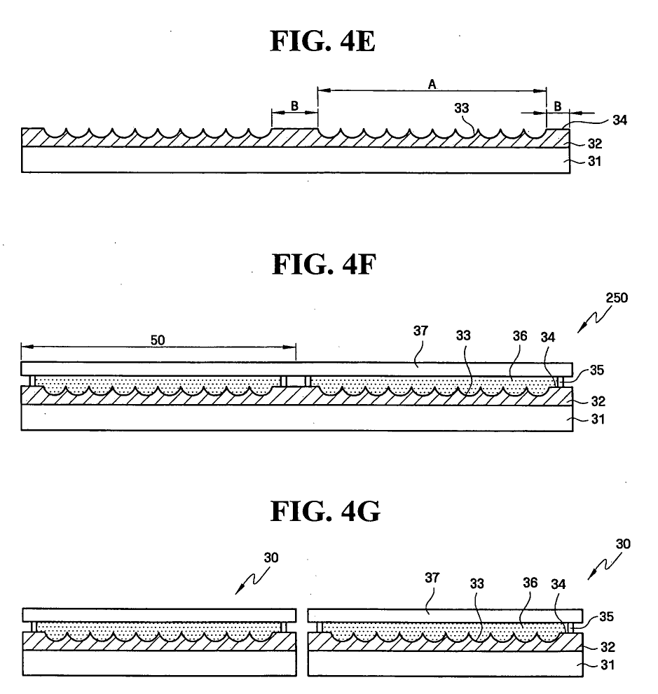

A method of manufacturing a microlens substrate according to an embodiment of the present invention will now be described with reference to FIGS. 4A-4G. FIGS. 4A-4G are cross-sectional views showing sequential process steps of the manufacturing method.

Referring to FIG. 4A, a lower substrate 31 and a mold film 300 for forming a lenticular lens array are prepared. The mold film 300 includes a base film 310, a mold layer 320 that is formed on the base film 310 and comprises a pattern for the lenticular lens array on one surface, and a microlens sheet 32 formed on the mold layer 320. The mold film 300 and the lower substrate 31 are disposed such that the microlens sheet 32 is interposed therebetween.

The mold film 300 may be, for example, a roll-type film. The roll-type mold film 300 is easy to carry and can be arranged on bulk glass at uniform intervals. Before positioning the mold film 300 and the lower substrate 31, an alignment key (not shown) may be formed on one surface of the lower substrate 31 facing the microlens sheet 32. The alignment key is used to position upper and lower substrates when a plurality of microlens substrates are formed simultaneously on bulk glass.

Referring to FIG. 4B, after attaching the mold film 300 onto the lower substrate 31, the microlens sheet 32 is thermally pressed down onto the lower substrate 31 by rolling a roller 330 having a temperature of about 80° C. to about 150° C. on the mold film 300.

Subsequently, as shown in FIG. 4C, the microlens sheet 32 is exposed to light through a mask 350 dividing the lenticular lens array on the lower substrate 31 cell by cell and defining a boundary between cells. The light 340 may be g line (436 nm), h line (405 nm), i line (365 nm), or ultraviolet (UV) light. The boundary between the cells is formed along edges of each cell. When the microlens sheet 32 comprising a negative type photosensitive resin is used as shown in FIG. 4C, the mask blocks the light 340 irradiating toward the boundary. When the microlens sheet 32 comprises a positive type photosensitive resin, the mask 350 may have a corresponding pattern. The microlens sheet 32 is hereinafter described to comprise a negative type photosensitive resin material.

Referring to FIG. 4D, the mold film 300 is removed so that only the microlens sheet 32 remains on the lower substrate 31.

Then, as shown in FIG. 4E, the microlens sheet 32 thermally pressed onto the lower substrate 31 is baked at about 200° C. to about 250° C. A lenticular lens array 33 is formed at a portion A of the microlens sheet 32 irradiated with the light 340 during the exposure. The remaining portion B of the microlens sheet 32 not irradiated with the light 340 is melted to form a planar surface 34 due to surface tension. The planar surface 34 is formed at the boundary between the cells.

Referring to FIG. 4F, seal lines 35 are formed on the planar surfaces 34, and a liquid crystal layer 36 is formed on a liquid crystal region of each cell 50 defined by the seal lines 35. Then, an upper substrate 37 is combined with the lower substrate 31 through the seal line 35, thereby completing the microlens substrate array 250.

Subsequently, as shown in FIG. 4G, the microlens substrate array 250 thus fabricated is cut into cells 50, thereby completing a plurality of microlens substrates 30.

As described above, when the plurality of microlens substrates 30 are fabricated simultaneously using bulk glass, the alignment keys are formed on the upper and lower substrates 37 and 31 for accurate positioning. The alignment keys may be used to achieve bonding between the upper and lower substrates 37 and 31 or to position the lower substrate 31 during the exposure shown in FIG. 4C. The alignment keys may also serve as a guide key for forming the seal lines 35 (FIG. 4F) or for forming an orientation layer prior to forming the liquid crystal layer 36.

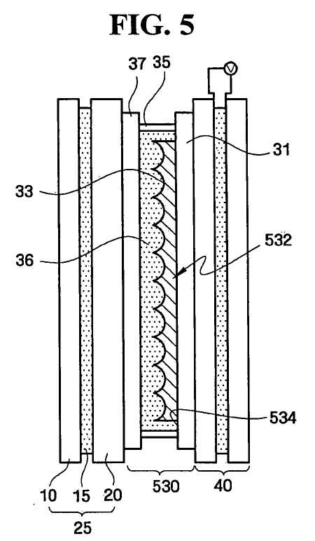

A 3D display apparatus according to an embodiment of the present invention and a method of manufacturing a microlens substrate array according to an embodiment of the present invention will now be described with reference to FIGS. 5-7G.

FIG. 5 is a cross-sectional view of the 3D display apparatus according to an embodiment of the present invention. The 3D display apparatus of FIG. 5 may be the landscape type display of FIG. 1A or the portrait type display of FIG. 1 B. Thus, FIG. 5 is a cross-sectional view taken along the lines AA′ or BB′ of the 3D display apparatus of FIGS. 1A or 1B.

Referring to FIG. 5, the 3D display apparatus includes substantially the same structure as that of FIG. 2, except for a microlens sheet 532 in a microlens substrate 530. For example, the microlens sheet 532 includes a lenticular lens array 33 comprising a plurality of lenticular lenses arranged in parallel and is removed along edges of the lenticular lens array 33 to expose a lower substrate 31 through a boundary 534 located at the edges of the lenticular lens array 33.

While the microlens sheet 532 is described to have the concave lenticular lens array 33, it may use a convex lenticular lens array to achieve the same effect.

Seal lines 35 are formed on the boundaries 534 located at the edges of the microlens sheet 532 and function to combine the upper substrate 37 with the lower substrate 31. The height of the seal lines 35 is greater than the thickness of the microlens sheet 532. For example, the seal lines 35 have a height of about several ten micrometers to about several hundred micrometers.

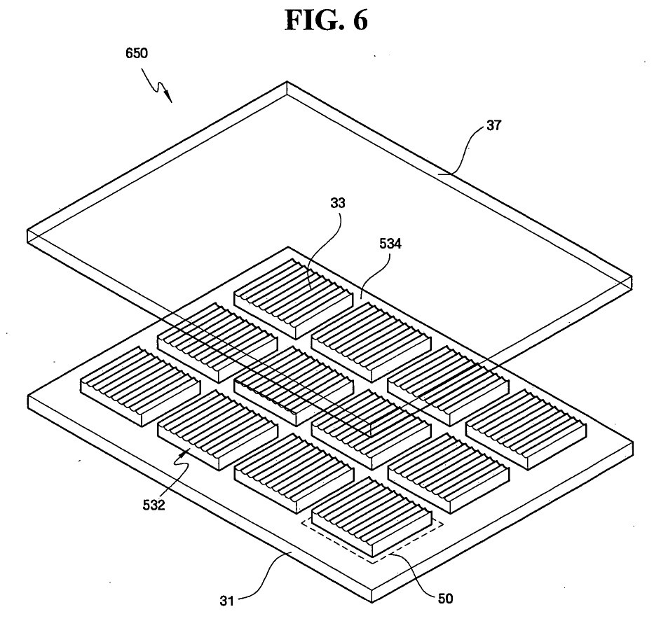

FIG. 6 is an exploded perspective view of a microlens substrate array 650 according to an embodiment of the present invention. The microlens substrate array 650 includes a plurality of microlens substrates 530.

Referring to FIG. 6, the microlens substrate array 650 includes a lower transparent substrate 31, an upper transparent substrate 37 facing the lower substrate 31, a plurality of portions of microlens sheet 532 that are spaced apart from each other and interposed between the upper and lower transparent substrates 37 and 31, and a plurality of lenticular lens arrays 33 corresponding to a plurality of cells 50 arranged on the surfaces of each portion of the microlens sheet 32.

The upper substrate 37 combines with the lower substrate 31 to cover a top surface of the lower substrate 31, with the portions of the microlens sheet 532 interposed therebetween.

The microlens sheet 532 comprises a photosensitive resin and includes the plurality of lenticular lens arrays 33 corresponding to the plurality of cells 50 arranged on the surface of the lower transparent substrate 31. The lower transparent substrate 31 is exposed along a boundary 534 of each cell 50. A seal line (not shown) is formed on each boundary 534 to achieve adequate bonding between the upper and lower substrates 37 and 31.

The plurality of cells 50 are defined on the microlens sheets 532 in the microlens substrate array 650. Thus, the microlens substrate array 650 can be cut into individual cells 50 and divided into a plurality of microlens substrates 530.

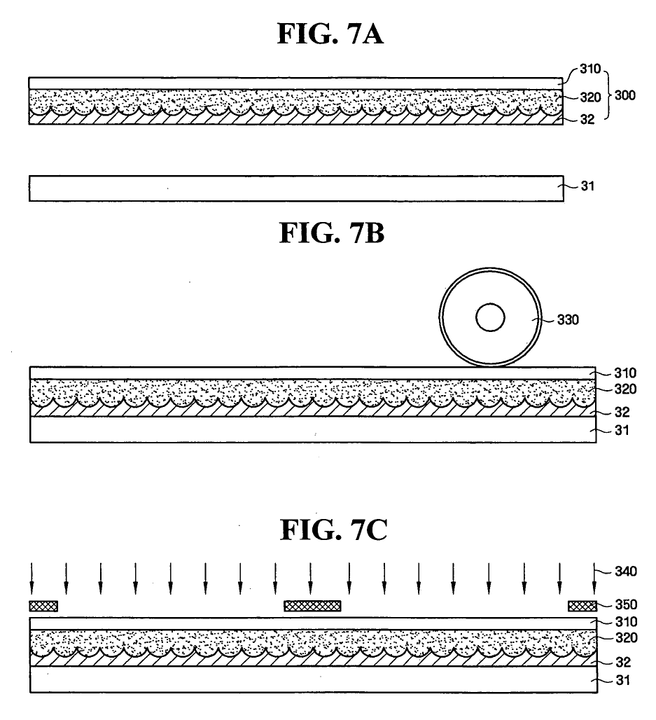

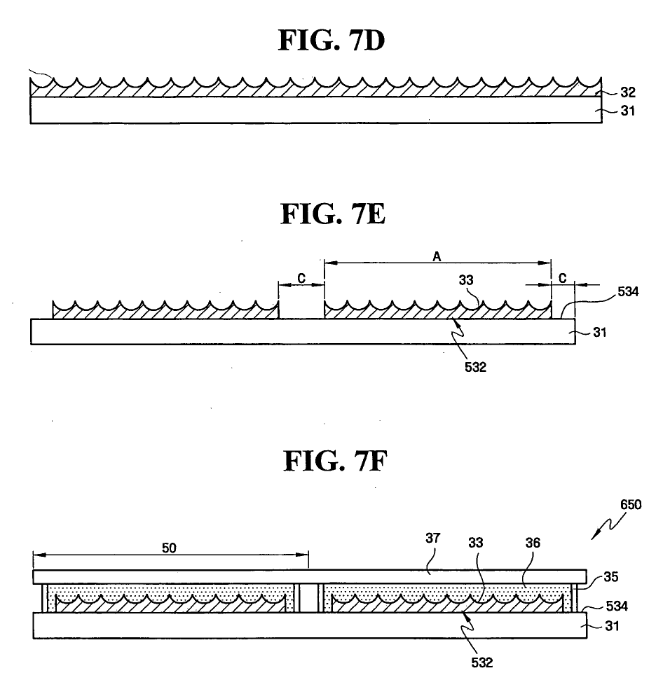

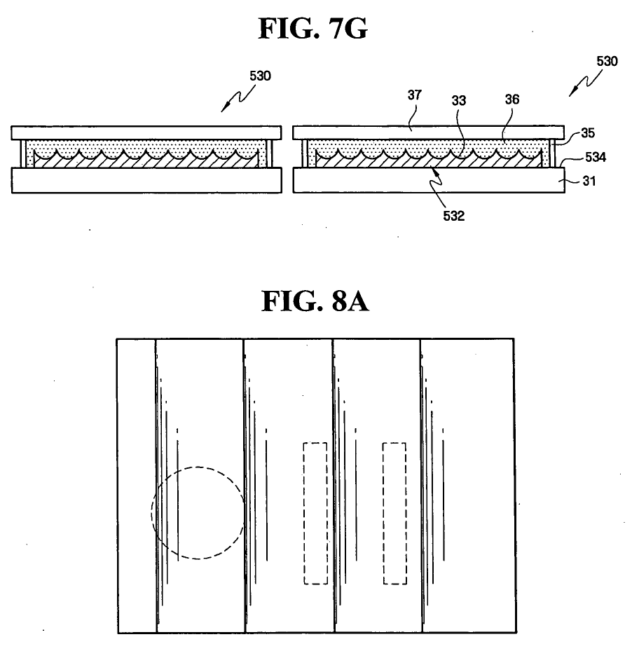

The method of manufacturing a microlens substrate 530 according to an embodiment of the present invention will now be described with reference to FIGS. 7A-7G. FIGS. 7A-7G are cross-sectional views showing sequential process steps of the manufacturing method. Since the process steps shown in FIGS. 7A-7D are the same as those shown in FIGS. 4A-4D, their description will not be given. Referring to FIG. 7E, the microlens sheet 32 formed on the lower substrate 31 is developed. After the developing step, portions A of the microlens sheet 532 irradiated with the light 340, corresponding to the lenticular lens array 33, remain. The remaining portions C of the microlens sheet 532, which are not irradiated with the light 340 during the exposure (FIG. 7C), corresponding to the boundary 534 between each cell, are removed. That is, the portions C of the microlens sheet 532 corresponding to the boundary 534 are removed with a developing solution.

Then, the microlens sheet 532 thermally pressed onto the lower substrate 31 is baked at about 200° C. to about 250° C. The lenticular lens array 33 is formed at the portions A of the microlens sheet 532 irradiated with the light 340 during the exposure. The remaining portions C of the microlens sheet 532 not irradiated with the light 340 are removed to expose the lower substrate 31.

Referring to FIG. 7F, seal lines 35 are formed on the boundaries 534 of the microlens sheet 532, and a liquid crystal layer 36 is formed on a liquid crystal region of each cell 50 defined by the seal lines 35. Then, an upper substrate 37 combines with the lower substrate 31 through the seal lines 35, thereby completing the microlens substrate array 650.

Subsequently, as shown in FIG. 7G, the microlens substrate array 650 thus fabricated is cut into cells 50, thereby completing a plurality of microlens substrates 530.

As described earlier, when the plurality of microlens substrates 530 are fabricated simultaneously using bulk glass, the alignment keys are formed on the upper and lower substrates 37 and 31 for precise positioning. The alignment keys may be used to achieve bonding between the upper and lower substrates 37 and 31 or to position the lower substrate 31 during the exposure shown in FIG. 7C. The alignment keys may also serve as a guide key for forming the seal lines 35 (FIG. 7F) or for forming an orientation layer prior to forming the liquid crystal layer 36.

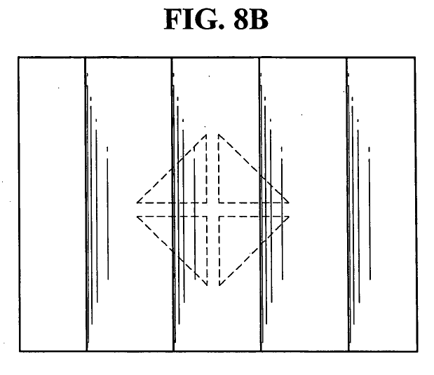

FIGS. 8A and 8B illustrate alignment keys that are formed on the lower substrate 31 shown in FIGS. 3 or 6 and transmitted to the overlying microlens sheet 32 or 532. As shown in FIGS. 8A and 8B, the geometry of the alignment keys formed on the lower substrate 31 and covered by the microlens sheet 32 or 532 can be visualized. The alignment keys may be formed at edges of an active area on the lower or upper substrate 31 or 37.

A microlens substrate array comprising a plurality of cells precisely aligned on bulk glass can be fabricated using the alignment keys.

As described above, embodiments of the present invention provide a microlens substrate array that can be fabricated on bulk glass to allow high-volume production, and with an alignment key formed on a substrate to provide excellent reproducibility and thus increase manufacturing yield, a method of manufacturing the same, and a 3D display apparatus including a microlens substrate.

Although preferred embodiments have been described with reference to the accompanying drawings, it is to be understood that the present invention is not limited to these precise embodiments but various changes and modifications can be made by one skilled in the art without departing from the spirit and scope of the present invention. All such changes and modifications are intended to be included within the scope of the invention as defined by the appended claims.

What is claimed is:

1. A microlens substrate array comprising:
an upper transparent substrate and a lower transparent substrate, wherein the lower transparent substrate faces the upper transparent substrate; and
a microlens sheet formed between the upper and lower transparent substrates, wherein the microlens sheet includes a plurality of lenticular lens arrays arranged on a surface of the microlens sheet and planar surfaces formed along edges of each of a plurality of cells, and wherein the plurality of lenticular lens arrays correspond to the plurality of cells.

2. The microlens substrate array of claim 1, wherein the microlens sheet comprises a photosensitive resin.

3. The microlens substrate array of claim 1, further comprising a liquid crystal layer formed in a gap between the upper and lower transparent substrates.

4. The microlens substrate array of claim 1, wherein the microlens sheet is formed on the lower transparent substrate and further comprises a seal line that is interposed between the planar surface of the microlens sheet and the upper transparent substrate and combines the upper transparent substrate with the lower transparent substrate.

5. The microlens substrate array of claim 1, wherein the microlens substrate array is cut into the plurality of cells to form a plurality of microlens substrates.

6. A microlens substrate array comprising:
an upper transparent substrate and a lower transparent substrate, wherein the lower transparent substrate faces the upper transparent substrate;
a microlens sheet including a plurality of lenticular lens arrays that are formed on the lower transparent substrate , wherein the plurality of lenticular lens arrays are formed between the upper and the lower transparent substrates and correspond to a plurality of cells, and the lower transparent substrate is exposed along edges of each of the plurality of cells; and
a seal line contacting the exposed lower transparent substrate and the upper substrate and combining the upper transparent substrate with the lower transparent substrate.

7. The microlens substrate array of claim 6, wherein the microlens sheet comprises a photosensitive resin.

8. The microlens substrate array of claim 6, further comprising a liquid crystal layer formed in a gap between the upper and lower transparent substrates.

9. The microlens substrate array of claim 6, wherein the microlens substrate array is cut into the plurality of cells to form a plurality of microlens substrates.

10. A three-dimensional display apparatus comprising:
a display panel producing an image; and
a microlens substrate including an upper transparent substrate that is disposed on the display panel and transmits the image, a lower transparent substrate facing the upper transparent substrate, and a microlens sheet that is formed between the upper and lower transparent substrates and includes a lenticular lens array and planar surfaces, wherein the planar surfaces are formed along edges of the lenticular lens array.

11. The three-dimensional display apparatus of claim 10, further comprising a liquid crystal layer formed in a gap between the upper and lower transparent substrates.

12. The three-dimensional display apparatus of claim 10, wherein the microlens sheet is formed on the lower transparent substrate between the upper and lower transparent substrates and the three-dimensional display apparatus further comprises a seal line that is interposed between the planar surface of the microlens sheet and the upper transparent substrate and combines the upper transparent substrate with the lower transparent substrate.

13. The three-dimensional display apparatus of claim 10, further comprising a switching panel that is disposed on the display panel and controls the three-dimensional display apparatus to selectively display a two- or three-dimensional image.

14. The three-dimensional display apparatus of claim 10, wherein the lenticular lens array comprises a plurality of concave lenses.

15. The three-dimensional display apparatus of claim 10, wherein alignment keys are formed at edges of at least one of the lower or upper transparent substrates.

16. A three-dimensional display apparatus comprising:
a display panel producing an image; and
a microlens substrate including:
an upper transparent substrate that is disposed on the display panel and transmits the image;
a lower transparent substrate facing the upper transparent substrate;
a microlens sheet including a lenticular lens array, wherein the lenticular lens array is formed on the lower transparent substrate between the upper and lower transparent substrates, and the lower substrate is exposed along edges of the lenticular lens array; and
a seal line contacting the exposed lower transparent substrate and the upper transparent substrate and combining the upper transparent substrate with the lower transparent substrate.

17. The three-dimensional display apparatus of claim 16, wherein the microlens sheet comprises a photosensitive resin.

18. The three-dimensional display apparatus of claim 16, further comprising a liquid crystal layer formed in a gap between the upper and lower transparent substrates.

19. The three-dimensional display apparatus of claim 16, further comprising a switching panel that is disposed on the display panel and controls the three-dimensional apparatus to selectively display a two- or three-dimensional image.

20. The three-dimensional display apparatus of claim 16, wherein the lenticular lens array comprises a plurality of concave lenses.

21. The three-dimensional display apparatus of claim 16, wherein alignment keys are formed at edges of at least one of the lower or upper transparent substrates.

22. A method of manufacturing a microlens substrate, the method comprising:
forming a microlens sheet including a lenticular lens array on a lower substrate;
exposing the microlens sheet to light through a mask dividing the lenticular lens array into a plurality of portions respectively corresponding to a plurality of cells and defining a boundary between each of the plurality of cells;
planarizing a portion of the microlens sheet corresponding to the boundary; and
forming a seal line on the planarized portion of the microlens sheet corresponding to the boundary to combine the lower substrate with a corresponding upper substrate.

23. The method of claim 22, wherein the microlens sheet comprises a photosensitive resin.

24. The method of claim 22, wherein forming the microlens sheet on the lower substrate comprises:
providing a mold film including a mold layer with a pattern for the lenticular lens array formed on a surface of the mold layer;
forming the microlens sheet on the mold layer;
interposing the microlens sheet between the lower substrate and the mold film; and
thermally pressing the mold film onto the lower substrate.

25. The method of claim 24, further comprising removing the mold film so that only the microlens sheet remains on the lower substrate.

26. The method of claim 24, wherein thermally pressing the mold film onto the lower substrate comprises:
disposing the mold film to face the lower substrate with the microlens sheet interposed therebetween; and
thermally pressing the microlens sheet onto the lower substrate by rolling a roller having a temperature of about 80° C. to about 150° C. on the mold film.

27. The method of claim 22, wherein the light is at least one of g line, h line, i line, or ultraviolet light.

28. The method of claim 22, wherein planarizing the portion of the microlens sheet comprises baking the microlens sheet at about 200° C. to about 250° C.

29. The method of claim 22, further comprising forming alignment keys on the lower substrate before forming the microlens sheet on the lower substrate.

30. The method of claim 22, further comprising forming a liquid crystal layer on the lower substrate after forming the seal line.

31. The method of claim 22, further comprising cutting a microlens substrate array into the plurality of cells after forming the seal line.

32. A method of manufacturing a microlens substrate, the method comprising:
forming a microlens sheet including a lenticular lens array on a lower substrate;
exposing the microlens sheet to light through a mask dividing the lenticular lens array into a plurality of portions respectively corresponding to a plurality of cells and defining a boundary between each of the plurality of cells;
removing a portion of the microlens sheet corresponding to the boundary to expose the lower substrate; and
forming a seal line on the exposed lower substrate to combine the lower substrate with a corresponding upper substrate.

33. The method of claim 32, wherein forming the microlens sheet on the lower substrate comprises:
providing a mold film including a mold layer with a pattern for the lenticular lens array formed on a surface of the mold layer;
forming the microlens sheet on the mold layer;
interposing the microlens sheet between the lower substrate and the mold film; and
thermally pressing the mold film onto the lower substrate.

34. The method of claim 33, wherein further comprising removing the mold film so that only the microlens sheet remains on the lower substrate.

35. The method of claim 33, wherein thermally pressing the mold film onto the lower substrate comprises:
disposing the mold film to face the lower substrate with the microlens sheet interposed therebetween; and
thermally pressing the microlens sheet onto the lower substrate by rolling a roller having a temperature of about 80° C. to about 150° C. on the mold film.

36. The method of claim 32, wherein the light is at least one of g line, h line, i line, or ultraviolet light.

37. The method of claim 32, wherein in the removing the portion of the microlens sheet comprises:
developing the microlens sheet; and
baking the microlens sheet at about 200° C. to about 250° C. after removing the portion of the microlens sheet.

38. The method of claim 32, further comprising forming alignment keys on the lower substrate before forming the microlens sheet on the lower substrate.

39. The method of claim 32, further comprising forming a liquid crystal layer on the lower substrate after forming the seal line.

40. The method of claim 32, further comprising cutting a microlens substrate array into the plurality of cells after forming the seal line.

41. The method of claim 32, wherein the microlens sheet comprises a photosensitive resin.
